(19) United States
(12) Patent Application Publication
(10) Pub. No.: US 2026/0099081 A1
(43) Pub. Date: Apr. 9, 2026

(54) OPTICAL APPARATUS

(71) Applicant: CANON KABUSHIKI KAISHA, Tokyo (JP)

(72) Inventors: KANAE NAKAMORI, Kanagawa (JP); MITSURU MOROHASHI, Tokyo (JP); AKIRA TAKAURA, Kanagawa (JP); KOHEI MATSUMOTO, Chiba (JP)

(21) Appl. No.: 19/416,559

(22) Filed: Dec. 11, 2025

Related U.S. Application Data
(63) Continuation of application No. PCT/JP2024/017882, filed on May 15, 2024.

(30) Foreign Application Priority Data
Jul. 21, 2023 (JP) 2023-118732

(51) Int. Cl. G03B 17/14

(52) U.S. Cl. CPC G03B 17/14

(57) ABSTRACT

An optical apparatus includes a first substrate having a main plane orthogonal to an optical axis direction of an optical system, and the first substrate having an inner diameter and an outer diameter, each of which is centered on the optical axis direction, a second substrate connected to the first substrate and having a main plane parallel to the optical axis direction, a fixed barrel that positions the first substrate while restricting a movement of the first substrate in the optical axis direction, and a connector between the first substrate and the second substrate disposed so as not to overlap a fixing portion for fixing a component different from the first substrate to the fixed barrel, when viewed from the optical axis direction. When viewed from the optical axis direction, at least a part of the fixed barrel is located inside the outer diameter.

### CROSS-REFERENCE TO RELATED APPLICATIONS

This application is a Continuation of International Patent Application No. PCT/JP2024/017882, filed on May 15, 2024, which claims the benefit of Japanese Patent Application No. 2023-118732, filed on July 21, 2023, which is hereby incorporated by reference herein in its entirety.

### BACKGROUND

### Field of the Technology

The aspect of the disclosure relates to one or more embodiments of an optical apparatus.

### Description of the Related Art

In recent years, the sizes of optical apparatuses such as digital cameras, video cameras, and interchangeable lenses have tended to increase along with the increasing size of control circuits mounted on a main substrate due to sophisticated functions, and the area of a main substrate, that is, the width of the main substrate has tended to increase.

Japanese Patent Application Laid-Open No. 2003-172863 discloses an electrical circuit board mounting structure for an interchangeable lens that provides flexibility in securing the board mounting area without increasing the width of the main substrate. More specifically, it discloses an electrical circuit board mounting structure including at least one hard substrate approximately orthogonal to the optical axis, at least one hard substrate approximately parallel to the optical axis, and a board-to-board connector connecting both hard substrates.

Japanese Patent Application Laid-Open No. 2003-172863 does not disclose the constraints on the components arranged around the hard substrates inside the interchangeable lens. Particularly, the zoom lens includes a connecting and rotating mechanism to move the barrel related to magnification variation forward and backward in an optical axis direction, and the arrangement of the hard substrates may be determined based on the relationship with the connecting and rotating mechanism.

### SUMMARY

An optical apparatus according to one aspect of the disclosure may include a first substrate having a main plane orthogonal to an optical axis direction of an optical system, and the first substrate having an inner diameter and an outer diameter, each of which is centered on the optical axis direction, a second substrate connected to the first substrate and having a main plane parallel to the optical axis direction, a fixed barrel that positions the first substrate while restricting a movement of the first substrate in the optical axis direction, and a connector between the first substrate and the second substrate disposed so as not to overlap a fixing portion for fixing a component different from the first substrate to the fixed barrel, when viewed from the optical axis direction. When viewed from the optical axis direction, at least a part of the fixed barrel is located inside the outer diameter. An optical apparatus according to another aspect of the disclosure may include a first substrate having a main plane orthogonal to an optical axis direction of an optical system, and the first substrate having an inner diameter and an outer diameter, each of which is centered on the optical axis direction, a second substrate connected to the first substrate and having a main plane parallel to the optical axis direction, a contact portion that electrically connects the first substrate to an image pickup apparatus, and a mount mechanically connectable to the image pickup apparatus. The second substrate is disposed between the first substrate and the mount, and disposed so as not to overlap the contact portion in either the optical axis direction or a radial direction.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are external views of a camera system according to a first embodiment.

FIG. 2 is a block diagram illustrating the configuration of the camera system according to the first embodiment.

FIG. 3 is a sectional view of the camera system (in a retracted state) according to the first embodiment.

FIG. 4 is a sectional view of the camera system (in an extended state) according to the first embodiment.

FIGS. 5A and 5B are perspective views of the first, second, and third substrates according to the first embodiment in a joined state.

FIGS. 6A and 6B explain the arrangement of the first to third substrates according to the first embodiment.

FIGS. 7A and 7B are perspective views of a linear guide barrel and a fixed barrel according to the first embodiment.

FIGS. 8A and 8B illustrate states before and after the first substrate is fixed to the fixed barrel in the first embodiment.

FIG. 9 is a sectional view of a camera system (in a retracted state) according to a second embodiment.

FIG. 10 is a sectional view of the camera system (in an extended state) according to the second embodiment.

FIGS. 11A and 11B explain the arrangement of first and second substrates according to the second embodiment.

FIG. 12 explains the arrangement of first and second substrates according to a third embodiment.

### DESCRIPTION OF THE EMBODIMENTS

Referring now to the accompanying drawings, a detailed description will be given of embodiments according to the disclosure. Corresponding elements in respective figures will be designated by the same reference numerals, and a duplicate description thereof will be omitted.

### FIRST EMBODIMENT

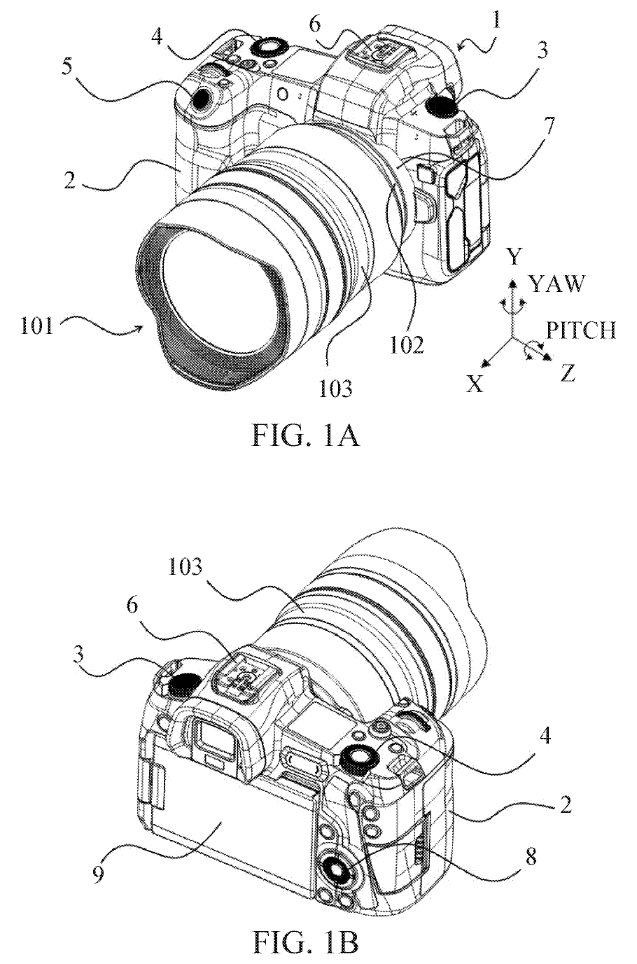

FIGS. 1A and 1B are external views of a camera system according to this embodiment. FIGS. 1A and 1B are front and rear perspective views, respectively. The camera system includes an interchangeable lens (optical apparatus) 101 and a digital camera (image pickup apparatus, referred to as a camera body hereinafter) 1 to which the interchangeable lens 101 is detachably attached. As illustrated in FIG. 1A, an optical axis direction along which the optical axis of the imaging optical system housed in the interchangeable lens 101 extends will be defined as an X-axis direction, and directions orthogonal to the X-axis direction will be defined as a Z-axis direction (horizontal direction) and a Y-axis direction (vertical direction). Hereinafter, the Z-axis direction and the Y-axis direction will also be collectively referred to as a Z/Y-axis direction. A rotation direction around the Z-axis will be defined as a pitch direction, and a rotation direction around the Y-axis will be defined as a yaw direction. The pitch direction and the yaw direction (also collectively referred to as the pitch/yaw direction hereinafter) are rotation directions around two axes, the Z-axis and the Y-axis, which are orthogonal to each other. In each embodiment, an interchangeable lens is described as an example of an optical apparatus, but this disclosure is also applicable to other devices such as lens-integrated cameras.

As illustrated in FIG. 1A, a grip portion 2 for the user to hold the camera body 1 is provided on the left side (right side when viewed from the rear) of the camera body 1 when viewed from the front (object side).

A power operation unit 3 is disposed on the top surface of the camera body 1. While the camera body 1 is in the power-off state, the user can turn on the power by operating the power operation unit 3, and thereby imaging becomes possible. While the camera body 1 is in the power-on state, the user can turn off the power by operating the power operation unit 3.

A mode dial 4, a release button 5, and an accessory shoe 6 are provided on the top surface of the camera body 1. The user can switch the imaging mode by rotating the mode dial 4. The imaging modes include a manual still image capturing mode in which the user can arbitrarily set an imaging condition such as a shutter speed and an aperture value (F-number), an automatic still image capturing mode that automatically obtains a proper exposure amount, and a moving image capturing mode for capturing a moving image. By half-pressing the release button 5, the user can instruct the camera to perform an imaging preparation operation such as autofocus (AF) and auto-exposure (AE) controls, and by fully pressing it, the user can instruct the camera to capture an image. Accessories such as an external flash and an external viewfinder (electronic viewfinder: EVF), which are not illustrated in FIGS. 1A and 1B, can be detachably attached to the accessory shoe 6.

The interchangeable lens 101 is mechanically and electrically connected to the camera mount 7 provided on the camera body 1 via a lens mount 102. As described above, the interchangeable lens 101 houses an imaging optical system that forms an object image using light from the object. A zoom operation ring 103 that can be rotated around the optical axis by user operation is provided on the outer circumference of the interchangeable lens 101. The outer circumference of the zoom operation ring 103 is provided with a knurled shape to prevent the user's hand from slipping during operation. When the zoom operation ring 103 is rotated by the user, the zoom unit constituting the imaging optical system moves to a predetermined optical position corresponding to the angle of the zoom operation ring 103. This operation allows the user to capture an image at a desired angle of view. The zoom unit includes a lens and a lens holding member that holds the lens.

As illustrated in FIG. 1B, a rear operation unit 8 and a display unit 9 are provided on the back of the camera body 1. The rear operation unit 8 includes a plurality of buttons and dials to which a plurality of functions are assigned. When the camera 1 is powered on and the still or moving image capturing mode is set, the display unit 9 displays a live-view image of an object being captured by the image sensor provided in the camera body 1. The display unit 9 displays imaging parameters indicating imaging conditions such as a shutter speed and an aperture value, and the user can change the setting values of the imaging parameters by operating the rear operation unit 8 while viewing the display. The rear operation unit 8 includes a playback button for instructing the playback of recorded images, and when the user operates the playback button, the captured image is displayed on the display unit 9.

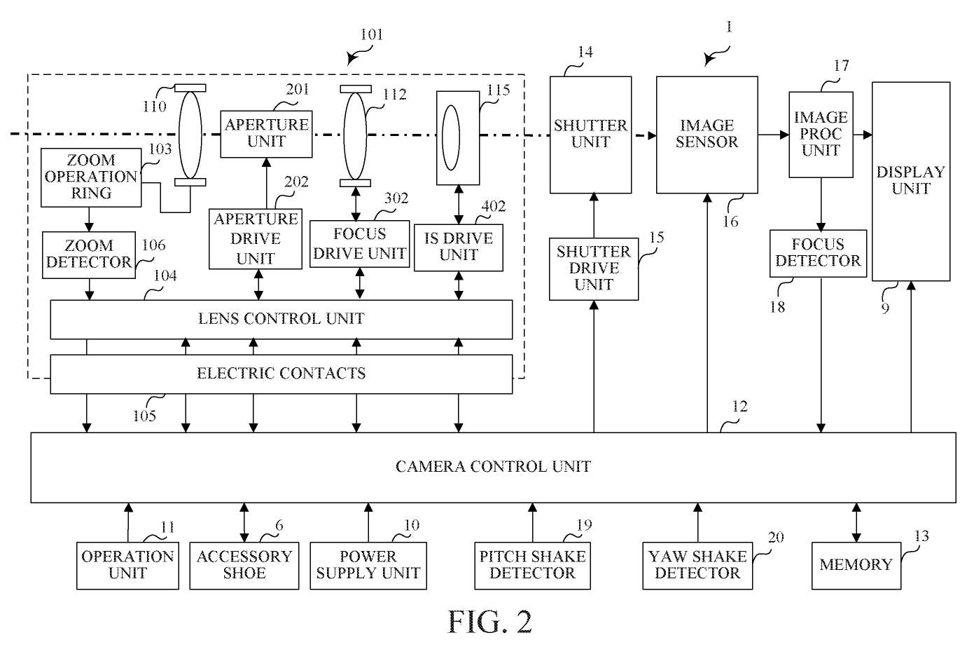

FIG. 2 is a block diagram illustrating the electrical and optical configuration of the camera system. The camera body 1 includes a power supply unit 10 that supplies power to the camera body 1 and the interchangeable lens 101, and an operation unit 11 including a power operation switch 3, a mode dial 4, a release button 5, a rear operation unit 8, and a touch panel function of the display unit 9.

The overall system control of the camera body 1 and the interchangeable lens 101 is performed by a camera control unit 12 provided in the camera body 1 and a lens control unit 104 provided in the interchangeable lens 101 communicating with each other. The camera control unit 12 reads and executes a computer program stored in the memory 13. At that time, the camera control unit 12 communicates with the lens control unit 104 via the communication terminals of electrical contacts 105 provided on the lens mount 102, communicating various control signals and data. The electrical contacts 105 include power terminals that supply power from the power supply unit 10 to the interchangeable lens 101.

The imaging optical system includes a zoom unit 110 that is connected to the zoom operation ring 103 and moves in the optical axis direction to change an angle of view. The imaging optical system further includes a lens image-stabilization (IS) unit 115 that includes a shift lens (image stabilizing lens) as an image stabilization element to reduce image blur. The lens IS unit 115 performs image stabilization by moving (shifting) the shift lens in the Z/Y axis direction orthogonal to the optical axis to reduce image blur. The imaging optical system further includes an aperture (stop) unit 201 that performs light amount adjustment, and a focus unit 112 that includes a focus lens that moves in the optical axis direction to perform focusing. The interchangeable lens 101 includes an IS drive unit 402 that drives the lens IS unit 115 to shift the shift lens, an aperture drive unit 202 that drives the aperture unit 201, and a focus drive unit 302 that drives the focus unit 112 to move the focus unit 112. In FIG. 2, the focus unit 112, the lens IS unit 115, and the aperture unit 201 are illustrated separately from the zoom unit 110, but as described later, they are included in the zoom unit 110.

The camera body 1 includes a shutter unit 14, a shutter drive unit 15, an image sensor 16, an image processing unit 17, and a camera control unit 12. The shutter unit 14 controls the amount of light condensed by the imaging optical system in the interchangeable lens 101 and exposed to the image sensor 16. The image sensor 16 photoelectrically converts (images) an object image formed by the imaging optical system and outputs an imaging signal. The image processing unit 17 performs various image processing on the imaging signal and then generates an image signal. The display unit 9 displays the image signal (live-view image) output from the image processing unit 17, displays imaging parameters, and plays back and displays captured images recorded in the memory 13 or an unillustrated recording medium.

The camera control unit 12 controls the driving of the aperture unit 201 and the shutter unit 14 via the aperture drive unit 202 and the shutter drive unit 15, respectively, according to the aperture value and shutter speed settings received from the operation unit 11. The camera control unit 12 also controls the driving of the focus unit 112 according to the imaging preparation operation (half-press operation) on the operation unit 11 (release button 5).

For example, when the AF operation is instructed, the focus detector 18 determines the focus state of the object image formed on the image sensor 16 based on the image signal generated by the image processing unit 17, generates a focus signal, and transmits it to the camera control unit 12. At the same time, the focus drive unit 302 detects the current position of the focus unit 112 and transmits a signal regarding the current position of the focus unit 112 to the camera control unit 12 via the lens control unit 104. The camera control unit 12 compares the focus state of the object image with the current position of the focus unit 112, calculates the shift amount, and transmits the focus drive amount to the lens control unit 104. The lens control unit 104 drives and controls the focus unit 112 to the target position via the focus drive unit 302, correcting the defocus of the object image.

When an AE control operation is instructed, the camera control unit 12 receives the luminance signal generated by the image processing unit 17 and performs photometric (light metering) calculation. Based on the photometric calculation result, the camera control unit 12 drives and controls the aperture unit 201 in accordance with the imaging instruction operation (full press operation) on the operation unit 11 (release button 5). The camera control unit 12 drives and controls the shutter unit 14 via the shutter drive unit 15 to perform exposure processing by the image sensor 16.

The camera body 1 has a pitch shake detector 19 and a yaw shake detector 20 as shake detectors capable of detecting image shake such as camera shake by the user. The pitch shake detector 19 and the yaw shake detector 20 each use an angular velocity sensor (vibration gyroscope) or an angular acceleration sensor to detect image shake in the pitch direction (rotation direction around the Z-axis) and the yaw direction (rotation direction around the Y-axis) and output a shake signal. The camera control unit 12 calculates the shift position of the lens IS unit 115 (shift lens) in the Y-axis direction using the shake signal from the pitch shake detector 19. Similarly, the camera control unit 12 calculates the shift position of the lens IS unit 115 in the Z-axis direction using the shake signal from the yaw shake detector 20. The camera control unit 12 then drives and controls the lens IS unit 115 to the target position according to the calculated shift positions in the pitch/yaw directions, performing image stabilization to reduce image blur during exposure and live-view image display.

The interchangeable lens 101 includes the zoom operation ring 103 for changing the angle of view of the imaging optical system, and a zoom detector 106 that detects the angle of the zoom operation ring 103. The zoom detector 106 uses, for example, a resistive linear potentiometer, and detects the angle of the zoom operation ring 103 operated by the user as an absolute value. The angle of view information detected by the zoom detector 106 is transmitted to the lens control unit 104 and reflected in various controls performed by the camera control unit 12 described above.

Part of the various types of information described above are recorded in the memory 13 and recording medium along with the captured image.

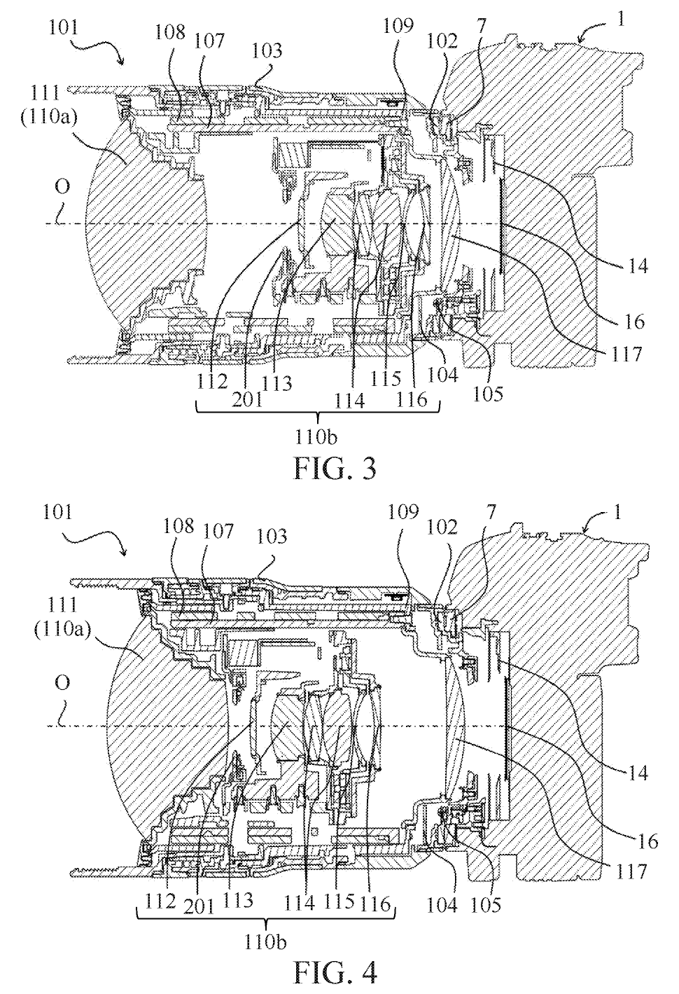

Referring now to FIGS. 3 and 4, a description will be given of a positional relationship between the components in the interchangeable lens 101 and the camera body 1. FIGS. 3 and 4 are sectional views of the camera system on the XY plane including the optical axis, illustrating the retracted and extended states of the zoom lens, respectively. A centerline O substantially coincides with the optical axis determined by the imaging optical system, and therefore, it will be considered synonymous with the optical axis below.

This embodiment adopts a seven-unit zoom configuration as an example of the imaging optical system. Each zoom unit, moved to a predetermined optical position according to the angle of view, forms an object image on the imaging surface of the image sensor 16 using light from the object. The focus unit 112 functions as the second zoom unit, and the lens IS unit 115 functions as the fifth zoom unit. The imaging optical system includes a first zoom unit 111, an aperture unit 201, a third zoom unit 113, a fourth zoom unit 114, a sixth zoom unit 116, and a seventh fixed unit 117. The zoom unit 110 includes an object-side zoom unit 110a and an image-side zoom unit 110b. The object-side zoom unit 110a includes the first zoom unit 111. The image-side zoom unit 110b includes the focus unit 112, the third zoom unit 113, the fourth zoom unit 114, the lens IS unit 115, the sixth zoom unit 116, and the aperture unit 201, and is configured by connecting them.

The configuration of the lens units is not limited to the configuration of this embodiment. For example, the lens IS unit 115 may function as the third zoom unit, or part of the lens units may be fixed instead of being movable.

A linear guide barrel 107 is fixed to a fixed barrel 109, and is fixed to the lens mount 102 via the fixed barrel 109. On the outer circumferential surface of the linear guide barrel 107, unillustrated bayonet claws are arranged at equally spaced positions. On the other hand, an unillustrated circumferential groove is provided on the inner circumferential surface of a cam barrel 108. The cam barrel 108 is connected to the zoom operation ring 103. When the zoom operation ring 103 is rotated, the cam barrel 108 rotates around the optical axis due to the engagement of the bayonet claws and the circumferential groove. The fixed barrel 109 fixes the first substrate 500 while restricting its movement in the optical axis direction, as described later.

The linear guide barrel 107 has linear guide grooves that restrict the movement of each zoom unit in the rotational direction and guide their linear movement in the optical axis direction. The cam barrel 108 also has cam grooves, each having a trajectory with a different angle in the rotational direction, corresponding to the object-side zoom unit 110a and the image-side zoom unit 110b. Each of the object-side zoom unit 110a and the image-side zoom unit 110b includes a cam follower, and each cam follower is engaged with the corresponding linear guide groove and cam groove. When the user rotates the zoom operation ring 103, the cam barrel 108 rotates, and the cam followers are engaged with the linear guide grooves and cam grooves, causing the object-side zoom unit 110a and the image-side zoom unit 110b to move back and forth in the optical axis direction along their respective trajectories.

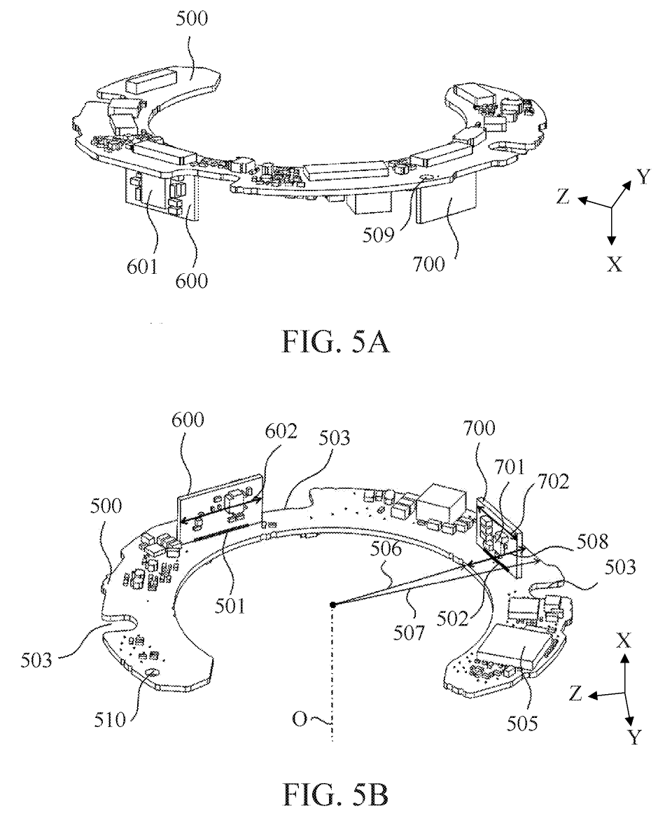

FIGS. 5A and 5B are perspective views of the first substrate 500, the second substrate 600, and the third substrate 700, which are included in the lens control unit 104, in a joined state. FIGS. 5A and 5B are views from different viewpoints. The centerline O is the optical axis.

The first substrate 500 has a main plane orthogonal to the optical axis. The second substrate 600 and the third substrate 700 have main planes parallel to the optical axis and are positioned on the projection of the first substrate 500. The first joint portion 501 is a solder joint between the first substrate 500 and the second substrate 600. The second joint portion 502 is a solder joint between the first substrate 500 and the third substrate 700. The second substrate 600 and the third substrate 700 are joined to the object-side surface of the first substrate 500. The first substrate 500 and the second substrate 600 or the third substrate 700 may be electrically conductive, so these substrates may be joined using a conductive resin.

The first substrate 500 includes a plurality of notch portions 503. The plurality of notch portions 503 have a shape that avoids the fastening portion of the fixed barrel 109 and the lens mount 102. The first joint portion 501 between the first substrate 500 and the second substrate 600 is not provided in the notch portions 503. Therefore, the second substrate 600 and the third substrate 700 are positioned to avoid the notch portions 503 in the optical axis direction.

The first screw hole 509 is located near the third substrate 700 (second joint portion 502) and is used to position and fix the first substrate 500 to the fixed barrel 109. Placing the second joint portion 502 near the positioning and fixing portion of the first substrate 500 and the fixed barrel 109 can suppress the bending of the first substrate 500 during a fall or other impact, and reduce the external force applied to the second joint portion 502, which can cause electrical connection failure. A second screw hole 510 is used to position and fix the first substrate 500 to the fixed barrel 109. In this embodiment, the second screw hole 510 is not located near the first joint portion 501, but it may be located near the first joint portion 501. Placing it near the first joint portion 501 can reduce the external force applied to the first joint portion 501. In this embodiment, the first screw hole 509 and a screw (not illustrated) engaged with the first screw hole 509 function as a positioning member. Similarly, the second screw hole 510 and a screw (not illustrated) engaged with the second screw hole 510 function as a positioning member.

In this embodiment, the first substrate 500 is fixed to the fixed barrel 109 with screws, but it may also be positioned via a buffer material such as rubber. In a case where the first substrate 500 is positioned on the fixed barrel 109 via a buffer material, the first substrate 500 may not be completely fixed to the fixed barrel 109. Not completely fixing it can reduce vibrations transmitted to each substrate via the fixed barrel 109.

A microcomputer 505 is mounted on the main plane of the first substrate 500. The second substrate 600 includes an IS driving IC 601 that controls the IS drive unit 402. The third substrate 700 includes a focus drive IC 701 that controls the focus drive unit 302.

The first substrate 500 has an arc shape, and the inner diameter of the first substrate 500, which is the first substrate inner diameter 506, and the outer diameter of the first substrate 500, which is the first substrate outer diameter 507, share the same center. This center is located on the centerline O. That is, a lens (optical element) included in the imaging optical system is disposed within the inner diameter of the first substrate 500. The shape of the first substrate 500 may not be a perfect circular arc shape; a part of the inner diameter 506 and the outer diameter 507 of the first substrate may have a different shape, such as a straight line.

A first substrate width 508, which is a difference between the inner and outer diameters of the first substrate 500, may be smaller than each of a second substrate width 602, which is the contact length between the second substrate 600 and the first substrate 500, and a third substrate width 702, which is the contact length between the third substrate 700 and the first substrate 500. Each substrate width may be wider than one side of the IC, which is the electrical element to be mounted.

Accordingly, mounting large electrical elements on the second substrate 600 and the third substrate 700 can reduce the first substrate width 508. Thereby, the first substrate outer diameter 507 can be reduced. Mounting the microcomputer 505 on the second substrate 600 can further reduce the first substrate width 508 and further reduce the first substrate outer diameter 507.

Soldering the first substrate 500 and the second substrate 600 together reduces the space for mounting a connector compared to connector joining, and the size of the camera system can be reduced.

The arrangement of the first substrate 500, the second substrate 600, and the third substrate 700 will be described below.

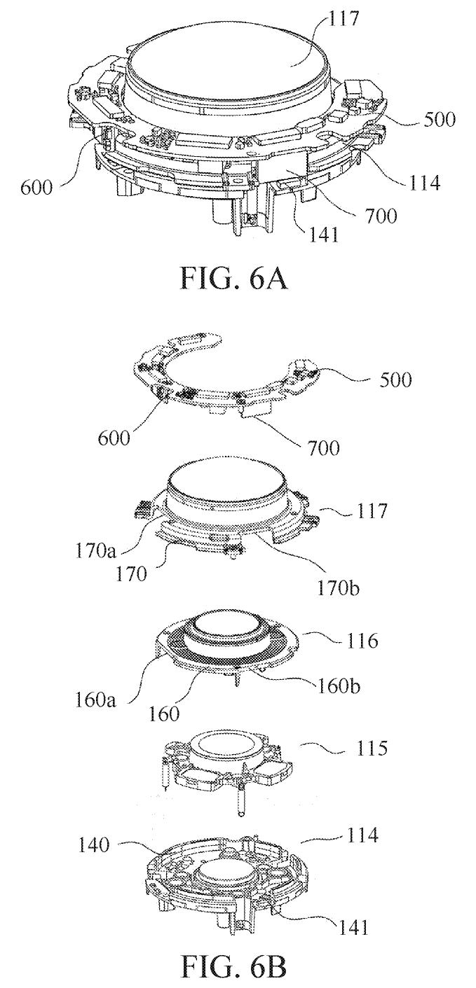

FIGS. 6A and 6B explain the arrangement of the first substrate 500, the second substrate 600, and the third substrate 700. FIGS. 6A and 6B are a perspective view and an exploded perspective view, respectively, of the first substrate 500, the second substrate 600, the third substrate 700, the fourth zoom unit 114, the lens IS unit 115, the sixth zoom unit 116, and the seventh fixed unit 117.

The fourth zoom unit 114 includes a lens and a fourth barrel 140 that holds the lens. The sixth zoom unit 116 includes a lens and a sixth barrel 160 that holds the lens. The sixth barrel 160 has notch portions 160a and 160b. The seventh fixed unit 117 includes a lens and a seventh barrel 170 that holds the lens. The seventh barrel 170 has notch portions 170a and 170b. The second substrate 600 is positioned in the notch portions 160a and 170a. The third substrate 700 is positioned in the notch portions 160b and 170b.

The seventh barrel 170 does not move back and forth in the optical axis direction, but the sixth barrel 160 moves back and forth in the optical axis direction in accordance with the zoom operation. Therefore, even when the sixth barrel 160 moves closest to the imaging surface (image), the sixth barrel 160 may maintain a gap between itself and the second substrate 600 and the third substrate 700.

In a case where an external force such as a drop impact is applied, and the second substrate 600 and the third substrate 700 come into contact with surrounding components, an external force will be applied to the first joint portion 501 and the second joint portion 502. Therefore, a gap of a predetermined value or more may be provided between the second substrate 600 and the third substrate 700 and the surrounding components in the substrate width direction, substrate thickness direction, and height direction. In a case where it is difficult to secure a gap of a predetermined value or more, for example, an elastic body (restricting member) 141 may be disposed between the third substrate 700 and the fourth barrel 140 in the optical axis direction. By sandwiching the third substrate 700 via the elastic material 141, the third substrate 700 does not come into contact with the surrounding components during a fall, and thus the external force applied to the second joint portion 502 can be reduced.

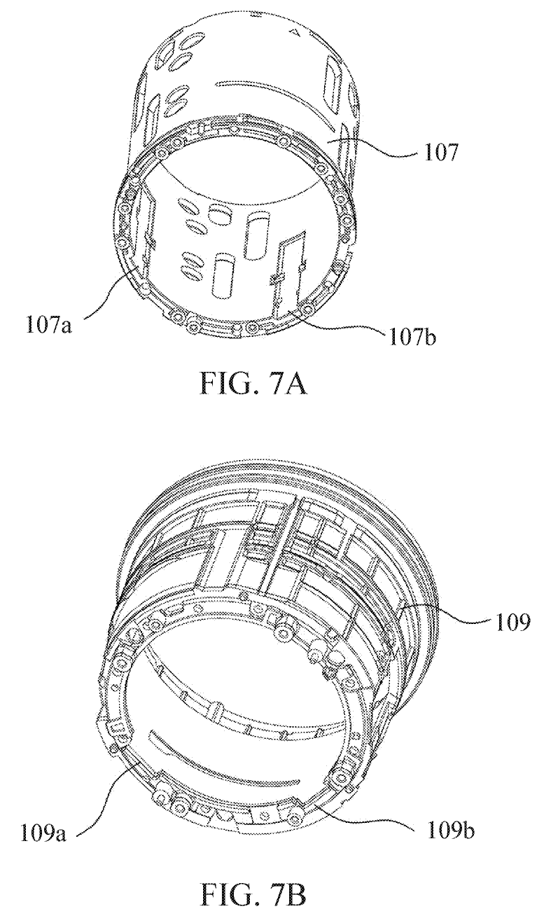

FIG. 7A is a perspective view of the linear guide barrel 107. FIG. 7B is a perspective view of the fixed barrel 109. Openings 107a and 107b are formed by cutting out the ends of the linear guide barrel 107 in the optical axis direction. The second substrate 600 is disposed in the opening 107a and the notch portion 109a of the fixed barrel 109. The third substrate 700 is disposed in the opening 107b and the notch portion 109b of the fixed barrel 109. As described above, in order to prevent external force from being applied to the first joint portion 501 and the second joint portion 502, a gap of a predetermined value or more may be provided between the second substrate 600 and the third substrate 700 and the surrounding components in the substrate width direction, substrate thickness direction, and height direction. Therefore, the openings 107a and 107b and the notch portions 109a and 109b are provided to create a gap between the linear guide barrel 107 and the fixed barrel 109 adjacent to the outer diameter side of the second substrate 600 and the third substrate 700. Thus providing the notch portions and openings in the fixed and movable parts can arrange the second substrate 600 and the third substrate 700 in the optical axis direction of the first substrate 500. This allows the first substrate 500 to be placed within the camera system with the second substrate 600 and the third substrate 700 joined to the main plane on the object side. Therefore, the size of the camera system can be reduced while the substrate mounting area can be secured.

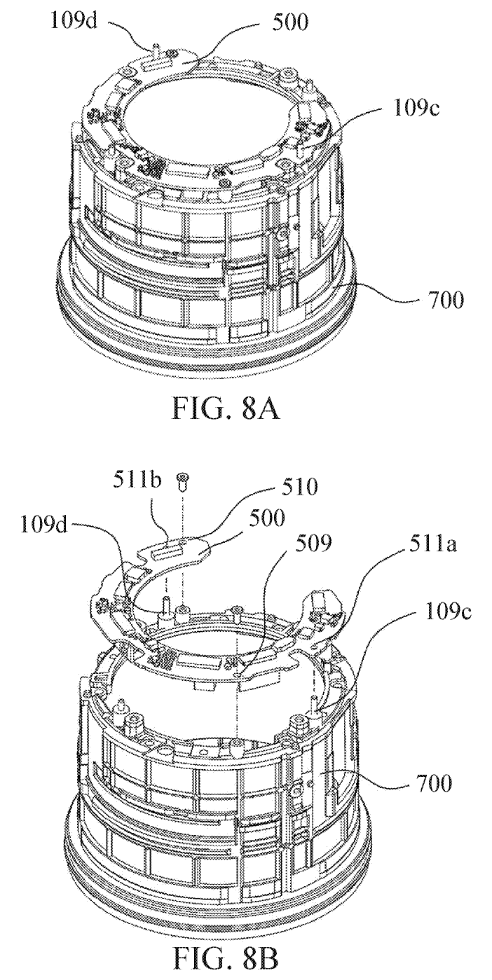

FIGS. 8A and 8B illustrate the states before and after the first substrate 500 is positioned and fixed to the fixed barrel 109. FIG. 8A illustrates assembly completion, and FIG. 8B is an exploded perspective view.

When viewed from the optical axis direction, the connectors with the first substrate 500, such as the first joint portion 501 and the second joint portion 502, are arranged so that the fixed barrel 109 does not overlap the fixing parts for fixing components different from the first substrate 500 (e.g., the linear guide barrel 107 and the lens mount 102, etc.). When viewed from the optical axis direction, at least a part of the fixed barrel 109 is located inside the outer diameter 507 of the first substrate.

When the first substrate 500 is incorporated into the fixed barrel 109, if the second substrate 600 and the third substrate 700 come into contact with the fixed barrel 109 first, external force will be applied to the first joint portion 501 and the second joint portion 502, causing electrical connection failure. Accordingly, the fixed barrel 109 includes guide pins (guide portions) 109c and 109d for incorporating the first substrate 500. The guide pins 109c and 109d are arranged to overlap the second substrate 600 and the third substrate 700 in a direction orthogonal to the optical axis (optical-axis orthogonality direction). The first substrate 500 has guide holes 511a and 511b corresponding to the guide pins 109c and 109d. The length of the guide pins 109c and 109d may be longer than the length of the second substrate 600 and the third substrate 700 in the optical axis direction. Making the length of the guide pins 109c and 109d longer than the length of the second substrate 600 and the third substrate 700 in the optical axis direction can achieve assembly while maintaining a gap between the fixed barrel 109 and the second substrate 600 and the third substrate 700. Thus, it becomes possible to assemble the first substrate 500 to the fixed barrel 109 while suppressing the generation of external forces applied to the first joint portion 501 and the second joint portion 502.

In this embodiment, the lens control unit 104 includes the first substrate 500, the second substrate 600, and the third substrate 700, but the disclosure is not limited to this embodiment. For example, the lens control unit 104 may not include the third substrate 700.

### SECOND EMBODIMENT

The basic configuration of a camera system according to this embodiment is similar to that of the camera system according to the first embodiment. This embodiment will discuss only the configurations that differ from those of the first embodiment, and those elements, which are corresponding elements in the first embodiment, will be designated by the same reference numerals, and a detailed description thereof will be omitted.

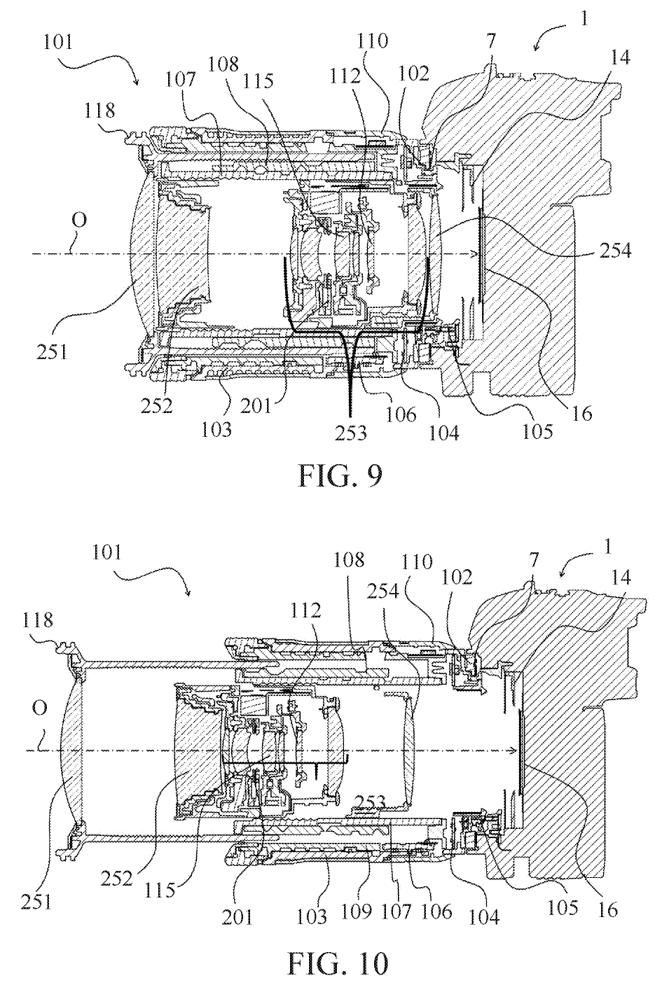

FIGS. 9 and 10 are sectional views of the camera system on the XY plane including the optical axis, illustrating the retracted and extended states of the zoom. The centerline O substantially coincides with the optical axis determined by the imaging optical system, and therefore it will be considered synonymous with the optical axis below.

This embodiment adopts a four-unit zoom configuration as an example of the imaging optical system. The focus unit 112, the lens IS unit 115, and an aperture unit 451 function as a third zoom unit 253. The imaging optical system includes a first zoom unit 251, a second zoom unit 252, and a fourth zoom unit 254. The configuration of the lens units is not limited to the configuration of this embodiment. For example, the focus unit 112 and the lens IS unit 115 may function as the second zoom unit. In addition, part of the lens units may be fixed instead of being movable.

The linear guide barrel 107 guides a movable barrel 118 that is movable in the optical axis direction, holds a cam barrel 108 that is rotatable around the optical axis, and houses a lens holding member that holds the lens. Cam grooves (not illustrated) are arranged at equally spaced positions on the outer circumferential surface of the linear guide barrel 107. On the other hand, a cam follower (not illustrated) is provided on the inner circumferential surface of the cam barrel 108. The cam barrel 108 is connected to the zoom operation ring 103. As the zoom operation ring 103 is rotated, the cam barrel 108 moves along the optical axis while rotating around the optical axis due to the engagement of the cam groove and the cam follower.

The linear guide barrel 107 has a linear guide groove (not illustrated) that restricts the rotational movement of the second to fourth zoom units 252 to 254 and guides their linear movements in the optical axis direction. A linear key is formed on the object side of the outer circumference of the linear guide barrel 107, which restricts the rotational movement of the first zoom unit 251 and guides its linear movement in the optical axis direction. The cam barrel 108 has cam grooves formed for each zoom unit, each with a different angle of trajectory in the rotational direction. Each of the first to fourth zoom units 251 to 254 includes a cam follower (not illustrated). The cam follower provided on the first zoom unit 251 is engaged with the cam groove 108a formed on the outer circumference of the cam barrel 108. The cam followers provided on the second to fourth zoom units 252 to 254 are engaged with the cam grooves 108b formed on the inner circumference of the cam barrel 108. When the user rotates the zoom operation ring 103, the cam barrel 108 rotates, and the cam followers provided on each zoom unit are engaged with the linear guide groove or linear guide key and the cam groove, causing each zoom unit to move simultaneously back and forth in the optical axis direction.

Next, the arrangement of the first substrate 500 and the second substrate 610 will be described. In the first embodiment, the second substrate 610 and the third substrate 700 are arranged by cutting out a part of the fixed components and barrel holding the lenses within the interchangeable lens 101. On the other hand, in this embodiment, the second substrate 610 is disposed in the openings provided in the linear guide barrel 107, the cam barrel 108, and the movable barrel 118. That is, the barrel holding the lens is disposed so as not to overlap radially the second substrate 610.

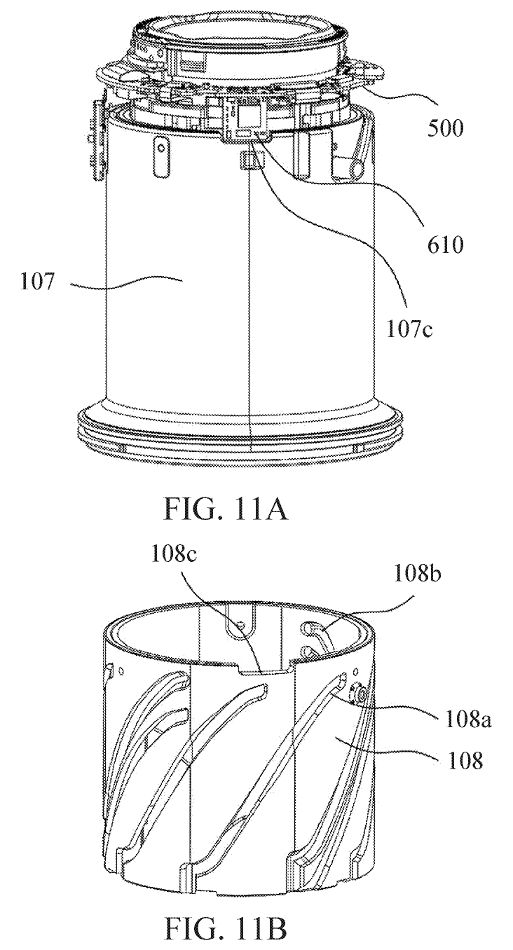

FIGS. 11A and 11B explain the arrangement of the first substrate 500 and the second substrate 610. FIG. 11A is a perspective view of the interchangeable lens 101 with the first substrate 500 and the second substrate 610 exposed. FIG. 11B is a perspective view of the cam barrel 108.

The opening 107c is formed by cutting out a portion at the end of the linear guide barrel 107 in the optical axis direction. The opening 108c is formed by cutting out a portion at the end of the cam barrel 108 in the optical axis direction. As described above, the linear guide barrel 107 has a linear guide groove (not illustrated). Cam grooves 108a and 108b, which function as moving portions, are formed on the outer and inner circumferences of the cam barrel 108, respectively. Since the cam followers provided in each zoom unit are engaged with the linear guide groove or linear key and the cam groove 108a or cam groove 108b, causing each zoom unit to move back and forth simultaneously in the optical axis direction, these grooves cannot be cut out. Therefore, it is necessary to provide the openings 107c and 108c in positions that do not overlap the linear guide groove, cam groove, or connecting members such as cam followers. That is, the length of the second substrate 610 in the optical axis direction is shorter than the distance from the first joint portion 501 to the cam grooves 108a and 108b.

As described above, the second substrate 610 can be space-efficiently disposed by providing openings at the ends of a plurality of moving barrels while the configuration necessary for lens driving is maintained. Thereby, the first substrate 500 can be disposed within the camera system with the second substrate 600 joined to the main plane on the object side. Therefore, this embodiment can reduce the size of the camera system while securing the substrate mounting area.

### THIRD EMBODIMENT

The basic configuration of a camera system according to this embodiment is similar to that of the camera system according to the first embodiment. This embodiment will discuss only the configurations that differ from those of the first embodiment, and those elements, which are corresponding elements in the first embodiment, will be designated by the same reference numerals, and a detailed description thereof will be omitted.

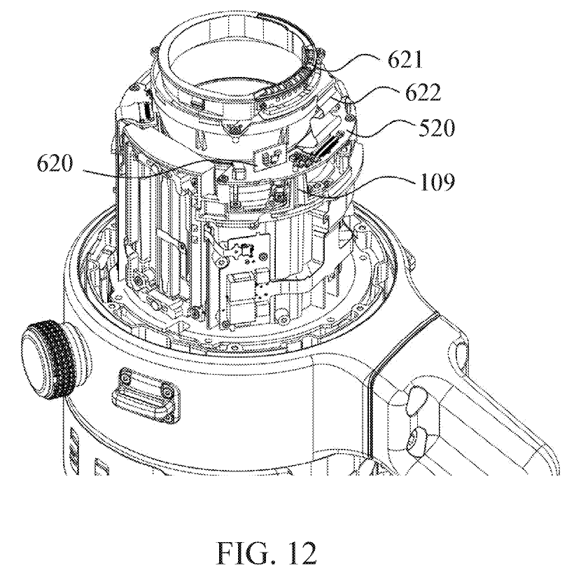

FIG. 12 explains the arrangement of the first substrate 520 and the second substrate 620, and is a partial perspective view of the interchangeable lens 101 with the first substrate 520 exposed. The first substrate 520 is positioned and fixed to the fixed barrel 109 with screws. The contact portion 621 is attached to the lens mount 102 and is mechanically and electrically connected to the contact portion of the camera mount 7. Thereby, the interchangeable lens 101 can be used for shooting as part of the camera system. A flexible printed circuit board (FPC) 622 electrically connects the first substrate 520 and the contact portion 621. A method for electrically connecting the first substrate 520 and the contact portion 621 may use another wiring unit such as lead wires instead of the flexible printed circuit board 622.

In the interchangeable lens 101 according to the first and second embodiments, the second substrate is joined to the object side of the first substrate. On the other hand, in this embodiment, the second substrate 620 is joined to the image sensor side of the first substrate 520.

In this embodiment, the lens mount 102 is attached to an external member (not illustrated), and may not provide a notch portion in the first substrate 520. Therefore, the second substrate 620 can be disposed anywhere on the surface of the first substrate 520, as long as it avoids the contact portion 621 and the flexible printed circuit board 622. That is, the second substrate 620 is disposed so as not to overlap the contact portion 621 in either the optical axis direction or the radial direction. In the gap between the lens mount 102 and the fixed barrel 109, the second substrate 620 is joined to the first substrate 520. Efficiently utilizing the space can reduce the size of the camera system without increasing the overall length of the lens while securing the substrate mounting area.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can provide an optical apparatus that has a reduced size and can secure a sufficient substrate mounting area.

What is claimed is:

1. An optical apparatus comprising:
a first substrate having a main plane orthogonal to an optical axis direction of an optical system, and the first substrate having an inner diameter and an outer diameter, each of which is centered on the optical axis direction;
a second substrate connected to the first substrate and having a main plane parallel to the optical axis direction;
a fixed barrel that positions the first substrate while restricting a movement of the first substrate in the optical axis direction; and
a connector between the first substrate and the second substrate disposed so as not to overlap a fixing portion for fixing a component different from the first substrate to the fixed barrel, when viewed from the optical axis direction,
wherein when viewed from the optical axis direction, at least a part of the fixed barrel is located inside the outer diameter.

2. The optical apparatus according to claim 1, further comprising a positioning member disposed near the connector and configured to position the first substrate to the fixed barrel.

3. The optical apparatus according to claim 1, further comprising a restricting member that restricts a movement of the second substrate in the optical axis direction.

4. The optical apparatus according to claim 1, wherein the fixed barrel includes a guide portion that guides the first substrate in the optical axis direction when the first substrate is attached to the fixed barrel.

5. The optical apparatus according to claim 1, further comprising:
a cam barrel rotatable about the optical axis direction;
a lens holding member disposed on an inner circumference of the cam barrel; and
a connecting member that connects the cam barrel and the lens holding member,
wherein the second substrate is disposed so as not to overlap any of the cam barrel, the lens holding member, and the connecting member in either the optical axis direction or a radial direction.

6. The optical apparatus according to claim 1, further comprising:
a cam barrel rotatable about the optical axis direction;
a lens holding member disposed on an inner circumference of the cam barrel; and
a connecting member that connects the cam barrel and the lens holding member,
wherein the cam barrel includes a moving portion that moves the lens holding member or the connecting member in the optical axis direction, and
wherein the second substrate is disposed between the first substrate and the moving portion.

7. The optical apparatus according to claim 1, further comprising a movable barrel movable in a direction parallel to the optical axis direction,
wherein the second substrate is disposed so as to overlap the movable barrel in the optical axis direction.

8. The optical apparatus according to claim 1, further comprising a cam barrel rotatable about the optical axis direction,
wherein the second substrate is disposed so as to overlap the cam barrel in the optical axis direction.

9. The optical apparatus according to claim 1, further comprising a lens holding member that holds a lens,
wherein the second substrate is disposed so as to overlap the lens holding member in the optical axis direction.

10. The optical apparatus according to claim 1, further comprising a guide barrel configured to guide a movable barrel movable in a direction parallel to the optical axis direction, to hold a cam barrel rotatable about the optical axis direction, or to house a lens holding member that holds a lens,
wherein the second substrate is disposed so as to overlap the guide barrel in the optical axis direction.

11. The optical apparatus according to claim 1, wherein the second substrate includes a control unit configured to control a lens,
wherein the second substrate is disposed on a projection of the first substrate, and
wherein a width of the first substrate is smaller than one side of the control unit.

12. The optical apparatus according to claim 1, further comprising an optical element disposed on a side of the inner diameter of the first substrate.

13. The optical apparatus according to claim 1, wherein the first substrate and the second substrate are joined by soldering.

14. The optical apparatus according to claim 1, wherein the first substrate and the second substrate are joined by a conductive resin.

15. An optical apparatus comprising:
a first substrate having a main plane orthogonal to an optical axis direction of an optical system, and the first substrate having an inner diameter and an outer diameter, each of which is centered on the optical axis direction;
a second substrate connected to the first substrate and having a main plane parallel to the optical axis direction;
a contact portion that electrically connects the first substrate to an image pickup apparatus; and
a mount mechanically connectable to the image pickup apparatus,
wherein the second substrate is disposed between the first substrate and the mount, and disposed so as not to overlap the contact portion in either the optical axis direction or a radial direction.
